(19) United States
(12) Patent Application Publication
(10) Pub. No.: US 2022/0147127 A1
(43) Pub. Date: May 12, 2022

(54) POWER LEVEL OF CENTRAL PROCESSING UNITS AT RUN TIME

(71) Applicant: Hewlett-Packard Development Company, L.P., Spring, TX (US)

(72) Inventors: Po Ying Chih, Taipei City (TW); Chao Wen Cheng, Taipei City (TW); Yen Tang Chang, Taipei City (TW); Wei Chieh Liao, Taipei City (TW); Yu Fan Chen, Taipei City (TW); Chien Chen Su, Taipei City (TW)

(73) Assignee: Hewlett-Packard Development Company, L.P., Spring, TX (US)

(21) Appl. No.: 17/418,801

(22) PCT Filed: Jul. 31, 2019
(86) PCT No.: PCT/US2019/044482

§ 371 Date: Jun. 26, 2021

(51) Int. Cl. G06F 1/20; G06F 1/26

(52) U.S. Cl. CPC G06F 1/206; G06F 1/26

(57) ABSTRACT

Techniques for allocating power budget to a central processing unit (CPU) of a computing device are described. According to an example of the present subject matter, a CPU is operated at default power level corresponding to a thermal design power (TDP) of the computing device. Thereafter, an unused power of the computing device is determined at run-time. The unused power is a difference between an allocated power budget of the component and current power consumption of the component, wherein the allocated power budget is an amount of power allocated to the component based on the TDP of the computing device. Based on the unused power the CPU is operated at a high-performance power level. The high-performance power level is a power level above the default power and up to a maximum power level of the CPU.

### BACKGROUND

Devices, such as smartphones, laptops, desktops, personal computers, and tablets, incorporate numerous components that generate heat during their operation. When a component, such as a processor of a device, operates under high workload, it may generate more heat than it generates during a normal operation. The heat is dissipated so as to maintain the temperature of the component within a predefined threshold. Accordingly, heat dissipating measures, such as heat-dissipating surfaces and cooling fans are incorporated in the devices.

### BRIEF DESCRIPTION OF FIGURES

The following detailed description references the drawings, wherein:

FIG. 1 illustrates a computing device enabling allocation of a power level to a central processing unit (CPU) of the computing device, in accordance with an example implementation of the present subject matter;

FIG. 2 illustrates the computing device, in accordance with another example implementation of the present subject matter;

FIG. 3 illustrates a method for allocating a power level to a CPU of a computing device, according to an example of the present subject matter;

FIG. 4 illustrates a method of determining unused power corresponding to various components of a computing device to change a power level of a CPU of the computing device in run-time, according to an example of the present subject matter; and

FIG. 5 illustrates a computing environment for allocating power budget to a CPU of a computing device, according to an example implementation of the present subject matter.

### DETAILED DESCRIPTION

Generally, power management in computing devices is achieved by allocating a power budget to components of a computing device for their operation. The allocation of the power budget to the components of the computing device ensures that a thermal design power (TDP) of the computing device is adhered to, TDP being a maximum power that can be dissipated by the computing device. Distribution of power budget between the components of the computing device is such that a sum of the power allocated to the individual components does not exceed the TDP.

The power budget allocated for an individual component within the computing device is generally reserved for the corresponding component alone and cannot be attributed to another component in case the former component is not utilizing the allocated power budget. For example, if 30 W is allocated to two universal serial bus (USB) ports of the computing device (15 W for one USB port), even when one USB port is not being used, the unused allocated power budget (15 W) remains reserved for that USB port.

In a similar manner, a central processing unit (CPU) of the computing device is also made to operate at a default power level based on a power budget allocated to the CPU according to the TDP of the computing device. The default power level is often set significantly below a maximum power level that the CPU is capable of handling, to achieve a rated frequency guaranteed by a manufacturer of the CPU. Also, since the default power level of the CPU is based on the ability of the computing device to dissipate heat, the default power level may often be defined for a worst-case scenario, such as a fan for the CPU having a low-rating. Accordingly, a significant margin may exist between the default power level and the maximum power level of the CPU.

Thus, the CPU may be operating at a default power level defined for TDP conformance assuming complete utilization of allocated power budget by the components, while the power budget allocated to the components of the computing device may not be utilized. In cases where power budget allocated to the components of a computing device is not utilized, for example, due to a component not being operational, operating the CPU at the default power level for TDP conformance may result in performance loss.

According to an example implementation of the present subject matter, techniques for configuring a power level of CPUs of computing devices, to minimize performance loss by the CPU are described. In an example, a CPU of a computing device is assigned a power level above a default power level set for TDP conformance based on the unutilized power budget allocated to the other components of the computing device.

In an example implementation, a central processing unit (CPU) of a computing device is initially operated at a default power level, for example, once the computing device is powered-on. The default power level corresponds to a thermal design power (TDP) of the computing device. Once the computing device is operational with the CPU running at the default power level, at run-time, an unused power of a component of the computing device is determined. The unused power is a difference between a power budget allocated to the component based on the TDP of the computing system, and a current power consumption of the component. Based on the determination of the unused power, the CPU may be operated at a high-performance power level. The high-performance power level is a power level above the default power level and may be equal to or less than a maximum power level of the CPU. As the unused power is not reserved for the corresponding component and is provided to the CPU to increase the power level of the CPU, the frequency of operation of the CPU increases. Increment of frequency of operation results in faster processing of workloads by the CPU.

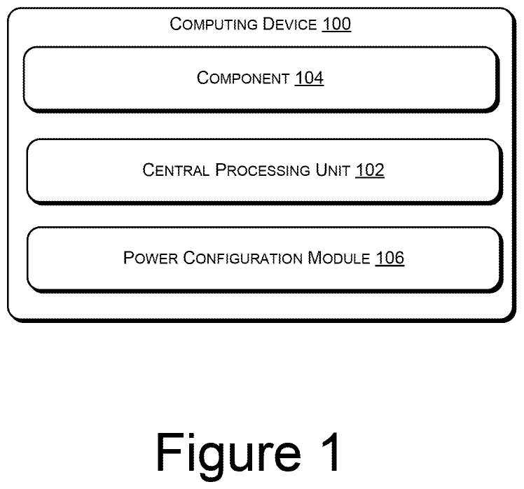

The above techniques are further described with reference to FIG. 1 to FIG. 5. It should be noted that the description and the figures merely illustrate the principles of the present subject matter along with examples described herein and should not be construed as limiting the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 shows a computing device 100 enabling allocation of a power level to a central processing unit (CPU) 102 of the computing device 100 at run-time, according to an example implementation of the present subject matter. Examples of the computing device 100 include, but are not limited to, an electronic device, such as a desktop computer, a personal computer, a laptop, a smartphone, a personal digital assistant (PDAs), and a tablet.

In an example, the CPU 102 of the computing device 100 may be implemented as microprocessors, microcomputers, microcontrollers, digital signal processors, central processing units, state machines, logic circuitries, and/or any devices that manipulate signals based on operational instructions. Among other capabilities, the CPU 102 is configured to fetch and execute computer-readable instructions stored in a memory (not shown in FIG. 1) of the computing device 100.

The computing device 100 further includes a component 104 communicatively coupled to the CPU 102. The component 104 may be any of a constituent of the computing device 100 incorporated to implement a functionality of the computing device 100. The component 104 may be a storage device, such as a storage device, for example, a dynamic random access memory (DRAM) device, static random-access memory (SRAM) device or a double data rate synchronous dynamic random-access memory (DRDRAM) device or a secondary storage device, for example, a programmable read-only memory (PROM) device, an erasable programmable read-only memory (EPROM) device or an electrically erasable programmable read-only memory (EEPROM) device. The component 104 may also be a processing device, such as a Random-Access Memory (RAM) or a graphics processor of the computing device 100. Further, it is also possible that the component 104 is an interface device that allows external devices to be coupled to the computing device 100. Examples of such component 104 include, but are not limited to, a universal serial bus (USB) port, a video graphics array (VGA) port, or a high-definition multimedia interface (HDMI) port.

In accordance with an example implementation of the computing device 100, the computing device 100 comprises a power configuration module 106 coupled to the CPU 102. In an example, the power configuration module 106 may be configured to perform power management related operations within computing device 100 and may comprises information for power management of the computing device 100. The power configuration module 106 may include routines, programs, objects, components, data structures, and the like, which perform particular tasks or implement particular abstract data types. The power configuration module 106 may further include electronic circuitry or a combination of electronic circuitry and control programs that may control various functions as described herein.

In an example, for power management of the computing device 100, the power configuration module 106 may assign a power budget to component 104 of the computing device 100. The power budget may be allocated based on a thermal design power (TDP) of the computing device 100. The TDP of the computing device 100 may be understood as an amount of power that can be dissipated by a cooling system of the computing device 100 per unit time. In an example, the TDP of a computing device 100 may be based on a rating of a fan of the CPU 102 of the computing device 100. Accordingly, the power level is assigned to the component 104 based on the power budget allocated to the respective component 104.

Further, based on the TDP of the computing device 100, a default power level may also be defined for the CPU 102 which may be lower than a maximum power level of the CPU. The CPU 102 may have a clock frequency or frequency of operation corresponding to the default power level and the maximum power level. In an example implementation, the default power level may be selected from amongst a plurality of configurable power levels of the CPU 102, namely P0-Pn, wherein, in an example, the P0 state may be the default power level and Pn may be the maximum power level. The power level P1-Pn may be higher than the default power level and may have higher corresponding clock frequencies. For example, the default power level of the CPU 102 may be 95 W (P0), while the CPU 102 may have other configurable higher power levels, such as 101 W (P1), 105 W (P2) and so on. In an example, the clock frequency corresponding to the default power level (P0:95 W) maybe 2.5 GHz, while the clock frequency corresponding to the power level 101w (P1) maybe 2.7 GHz and the clock frequency corresponding to the power level 105 W (P2) maybe 2.9 GHz. In this example, the 105 w may be considered as the maximum power level of the CPU.

In operation, once the computing device 100 is booted and the computing device 100 starts running, the CPU 102 operates at the default power level. Simultaneously, the component 104 may operate at a power level lower than or equal to the allocated power budget. At run-time, the component 104 may consume less power than allocated due to a variety of reasons, such as the component 104 being non-operational, or being rendered malfunctional. To explain using an example, the component 104 may be a universal serial bus (USB) port having a maximum current delivering capacity of 4 amperes (A) and an allocated power budget of 20 W. However, in some scenarios, the USB port may be non-operational or consume zero power if no external device is coupled to the USB port. In some cases, the USB port may be operational yet consume less than its allocated power budget. For example, if a USB device having a current rating of 2 A is coupled to the USB port and is correspondingly being supplied 2 A current by the USB port that is otherwise capable of delivering upto 4 A, the USB port may consume a power less than allocated power budget.

Thus, in cases where the component 104 is consuming power lower than the allocated power budget, an unused power corresponding the component 104 exists, the unused power being the difference between the current power consumption of the component 104 and the allocated power budget of the component 104.

In accordance with an example implementation of the present subject matter, the power configuration module 106 sets a power configuration of CPU 102 to a high-performance power level based on the unused power. In other words, based on the estimation of unused power corresponding the component 104 and similarly other components of the computing device 100 at run-time, the power configuration module 106 changes the default power level to the high-performance power level, wherein the high-performance power level is a power level above the default power level and up to the maximum power level of the CPU 102.

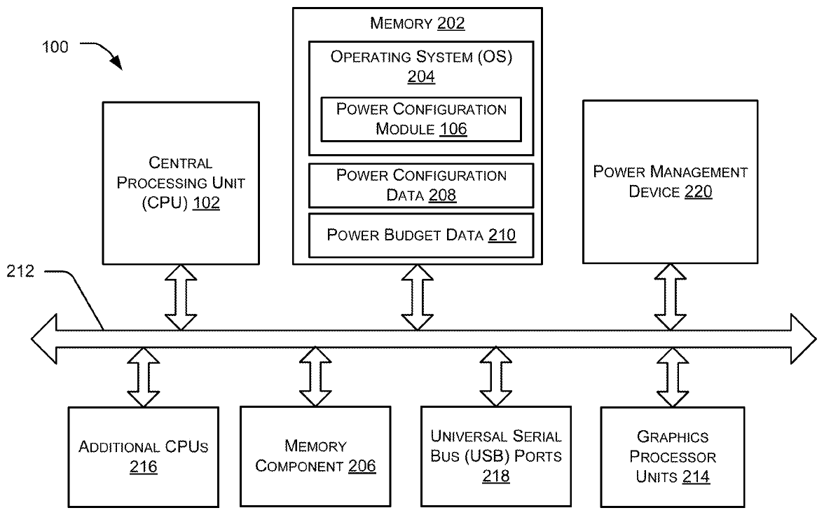

FIG. 2 illustrates the computing device 100, in accordance with another example implementation of the present subject matter. As described earlier, the computing device 100 comprises the CPU 102 that is coupled to a memory 202 hosting an operating system (OS) 204 of the computing device 100.

The functions of the various elements shown in the figures, including any functional blocks labelled as “CPU”, may be provided through the use of dedicated hardware as well as hardware capable of executing software. When provided by a CPU, the functions may be provided by a single dedicated CPU, by a single shared CPU, or by a plurality of individual CPUs, some of which may be shared. Moreover, explicit use of the term “CPU” should not be construed to refer exclusively to hardware capable of executing software, and may implicitly include, without limitation, digital signal processor (DSP) hardware, network processor, application specific integrated circuit (ASIC), field-programmable gate array (FPGA), read-only memory (ROM) for storing software, non-volatile storage. Other hardware may also be included. Among other capabilities, the CPU 102 is configured to fetch and execute computer-readable instructions stored in the memory 202.

The memory 202 may include any computer-readable medium including, for example, volatile memory (e.g., RAM), and/or non-volatile memory (e.g., EPROM, flash memory, etc.). In an example, the memory 204 may be a Parallel Advanced Technology Attachment (PATA) type memory device, a serial advanced technology attachment (SATA) type memory device, small computer system interface (SCSI) type memory device, solid-state drive (SSD) type memory device or a combination thereof. Further, the computing device 100 may include a memory component 206 similar to the memory 202. The memory component 206 may act as an additional storage space for the computing device 100.

In an example implementation, the memory 202 may comprise the power configuration module 106. Further, the memory 202 may also store power configuration data 208. The power configuration data 208 may comprise information about the configurable power levels of the CPU 102. Further, the memory 202 may also store power budget data 210 comprising information about the allocated power budget of the various components of the computing device 100. These various components may be coupled to the CPU 102 via a system bus 212. The system bus 212 may include a control bus, an address bus, and a data bus of the computing device 100. The system bus 212 may be used for communicating between the components and the CPU 102 of the computing device 100.

The components of the computing device 100 may include one or more graphics processor units (GPUs) 214 to perform the processing of complex and detailed images, animations, videos, etc.

Further, in an example, the computing device 100 may be a multiprocessor computing device 100 and the computing device 100 may employ additional CPUs 216. For example, in a multiprocessor configuration of the computing device 100, the computing device 100 may include a first CPU, hosting a first OS, and a second or an additional CPU, hosting a second OS, such that both the first and the second OS enable different functionalities in the computing device 100.

Thus, the above described components, such as the memory 202, the memory component 206, the additional CPU 216, GPUs 214 are the constituent components of the computing device 100. In addition to such constituent components, as explained in the FIG. 1, the computing device 100 may further include components, such as interface components that provide for coupling of external devices with the computing device 100. Accordingly, the computing device 100 may comprise a universal serial bus (USB) port 218 for interfacing USB-type devices with the computing device 100. In an example, the USB port may be a USB-A type port, a USB-B type port, a USB-C type port, thunderbolt USB, micro USB port, mini USB port etc. In an example, the USB port may have power delivery capability or charging capability.

Further, the computing device 100 may comprise a power management device 220 for monitoring a real-time power consumption of the computing device 100. For the purpose, the power management device 220 may be communicatively coupled to the various components of the computing device 100 to monitor their operation and estimate the real-time power consumption of the computing device 100.

In operation, when the computing device 100 is powered ON, a booting process is initiated by a basic input output system (BIOS) of the computing device 100. During the booting process the components that are coupled with the computing device 100 are detected and are interfaced with the OS 204. Further, during the booting process, a power budget may be allocated to the components of the computing device 100 based on the TDP of the computing device 100. Upon completion of the booting process, the computing device 100 is ready for use and at run-time, the CPU 102 operates at default power level which is also based on the TDP of the computing device 100.

According to the present subject matter, to determine the unused power corresponding to the components of the computing device 100 during run-time of the computing device 100, a status of each of the components is determined by the power configuration module 106. In an example, the status of a component may be operational, non-operational, and malfunctioned. In operational state, the component may consume electrical power while in the non-operational state and malfunctioned state the component may not consume any power.

The power configuration module 106 may determine the current power consumption of a component 104 based on the status of the component 104. In an example, the status of a component may be determined based on interfacing of the component with the OS 204 of the computing device 100. If the component is interfaced with the OS 204 of the computing device 100 at run-time, the status of the component may be determined to be operational, while if the component is not interfaced with the OS 204, the status of the component may be determined to be non-operational or malfunctioned. In an example, the operational state of a component may include an idle state and an active state of the component, wherein in the idle state, the component may consume less electrical power than in the active state.

For the constituent components, such as memory component 206, graphics processor unit 214, if the status of the component is ‘operational’, the component may be ascertained to consume power in accordance with the allocated power budget. For example, if the status of the memory component 206, having an allocated power budget of 30 W, is found to be operational, the power configuration module 106 may consider that the current power consumption of the memory component 206 corresponds to the allocated power budget of 30 W. Similarly, in another example, if the additional CPU 216 is found to be operational, the power configuration module 106 may determine that the additional CPU 216 may be operating so as to consume its entire allocated power budget. However, if the state is determined to be non-operational or malfunctioned, the current power consumption is determined to be zero.

Thus, in the operational state, the constituent components may consume their respective allocated power budget. Accordingly, if a constituent component is detected to be operational, the power configuration module 106 may retrieve the allocated power budget corresponding to the component stored in power budget data 210, which in this case is ascertained as the current power consumption of the component.

Further, as explained earlier, the interface components, interchangeably referred to as interface devices, such as the USB port 218, may consume less power than the allocated power budget in operational state. The USB driver module provides to the power configuration module 106 an indication regarding the power consumed by the USB port 218. When a USB-type device is coupled with the USB port 218, the USB driver module performs a handshake with the USB type device coupled to the USB port 218. Handshaking determines power requirement of the USB-type device and accordingly, the power is delivered to the USB-type device. There may be a variety of USB type ports and USB-type devices, each having their own power configurations and capabilities. For example, a USB-C type device would consume 4 A of current when connected to a USB-C type ports. The USB driver module determines the type of USB-type device coupled with the USB port 218 and accordingly provides the electrical power to the USB-type device. In an example, the USB port 218 may be capable of delivering 40 W of power with a voltage of 5 W and 8 A current, however the coupled USB-type device may be a C-type USB device and may consume 20 W (4 A, 5V). Thus, in this case, even when the USB port 218 is operational, the USB port 218 does not consume allocated power budget of 40 W, rather consumes a power of 20 W. Thus, the current power consumption of the USB port 218 is determined to be 20 W in this case. However, in non-operational state and malfunction state, the USB port 218 consumes zero power, similar to the components, such as the memory component 206, the additional CPU 216 of the computing device 100.

In the example implementation illustrated in FIG. 2, the interface component USB 218 is shown, however, the computing device 100 may have other interface components such as, VGA port, HDMI port etc.

Based on the current power consumption of the components, the power configuration module 106 determines an unused power of the computing device 100. In an example, the power configuration module 106 may compare the power budget of the components with their current power consumption to determine the unused power.

For example, the current power consumption of the memory component 206 may be determined to be zero due to memory component 206 being non-operational or malfunctioned. As the allocated power budget of the memory component 206 is not being used, the power budget allocated to the memory component 206 is determined as unused power. Similarly, in another example the graphics processor unit 214 may be malfunctioned and the allocated power budget for the graphics processor unit 214 may be determined to be the unused power. In yet another example, the additional CPU 216 may be not initialized or non-operational and thus, the allocated power budget of the additional CPU 216 may be determined to be the unused power. Further, as explained above, the unused power of the interface component, such as the USB port 218, may be determined based on an indication provided by the USB driver module.

Having made the determination of the unused power, the power configuration module 106 may configure a power level of the CPU 102 of the computing device 100. In an example, the CPU 102 may have configurable power levels, from P0-Pn, P0 being the default power level and the Pn being the maximum power level. The power level information of the CPU 102 may be stored in the power configuration data 208 of the computing device 100. In an example, the configurable power levels may have associated operating parameters, such as operating temperature, operating frequency, maximum temperature, etc. For example, an 85 W (P0) power level of the CPU 102 may have an operating temperature of 40° C., operating frequency of 2.5 Ghz, a maximum temperature of 60° C. Similarly, a 100 W (P1) power level of the CPU 102 may have an operating temperature of 40° C., operating frequency of 2.5 Ghz, the maximum temperature of 60° C., in an example. The power level of the CPU 102 along with the details of other parameters, such as temperature and frequency of operation, may be called as power configuration of the CPU 102.

The power configuration module 106 may access the power configuration data 208 to determine the high-performance power level for the CPU 102 based on the unused power. Once the high-performance power level is determined, the power confirmation module 106 may change the power level of the CPU 102 from the default power level to the high-performance power level. In an example, to change the power level of the CPU 102, the power configuration module 106 may change a power level value in a model specific register (MSR) of the CPU 102. The power level provided to the CPU 102 is based on the power level value mentioned in the MSR. Thus, in an example, to change the power level of the CPU 102, the power configuration module 106 may change the power level value in the MSR to a power level value corresponding to the high-performance level.

Considering an example, if the unused power is determined to be 15 w, a default power level of the CPU 102, which may be 85 w, for instance, may be revised to a high-performance level of about 100 W, (85 W+15 W).The power configuration module 106 changes the power level of the CPU 102 from the default power level to the high-performance level, such that the high-performance level corresponds to one of the higher configurable power levels of the CPU 102. For example, the change in power level may be in proportion to unused power. For example, if it is determined that the unused power is 40 W, the power configuration module 106 may configure the power level of the CPU 102 from the default power level 85 W (P0) to a high-performance power level of 115 W (P2) (85 W+40 W). Thus, in this case, an intermediate power level of 100 W of the CPU 102 may be bypassed.

In an example implementation, in addition to determination of a status of the components, the power configuration module 106 also determines a real-time power consumption of computing device 100 for changing the power level of the CPU 102. In an example, the real-time power consumption of computing device 100 may be determined by the power management device 220. The power management device 220 of the computing device 100 may be understood as a device comprising of electronic circuitry to monitor the power consumption of the computing device 100. In an example, the power management device 220 may monitor the current drawn from an electrical supply or a battery of the computing device 100, and based on the same, may calculate the power consumption of the computing device 100. The power management device 220 monitors power consumption of the computing device 100 and provides the real-time power consumption information to the power configuration module 106.

Based on the real-time power consumption of computing device 100 and the current power consumption of the each of the components of computing device 100, the real-time power consumption of the CPU 104 may be estimated. In an example, to determine real-time power consumption of the CPU 102, the current power consumption of the components is subtracted from the real-time power consumption of the computing device 100. In an example, if the real-time power consumption, i.e., the overall power consumption of computing device 100, as determined by the power management device 220, is 80 W and the sum of current power consumption of the components, as determined by the power configuration module 106, is 40 W, the CPU's 102 real-time power consumption may be determined to be 40 W (80 W−40 W).

In an example, the power configuration module 106 may configure the high-performance level based on the real-time power consumption of the CPU 104. For example, if the CPU 102 is determined to be operating substantially below its default power level, the high-performance level of the CPU 102 may be configured to a higher power level such that a substantial portion of the unused power is utilized. However, in cases where the CPU 102 is operating substantially close to the default power level, the high-performance level may be selected such that the change in power level may not be in proportion to unused power. In the latter case, though the high-performance level is greater than the default power level defined in accordance with the TDP of the computing device 100, the difference between the high-performance level and the default power level may not be very significant, for example, the difference may not be as large as in the former case. In an example implementation, the power configuration module 106 may implement a threshold to configure the high-performance level, based on the real-time power consumption of the CPU 104

In an example, above described techniques of determination of the unused power and changing power level of the CPU 102 can be performed periodically in a predefined frequency or may be trigged based on a change in status of a component. The change of status may include a component going non-operational during runtime, a component malfunctioning during runtime etc. Such status change may be detected by the OS 204 of the computing device 100.

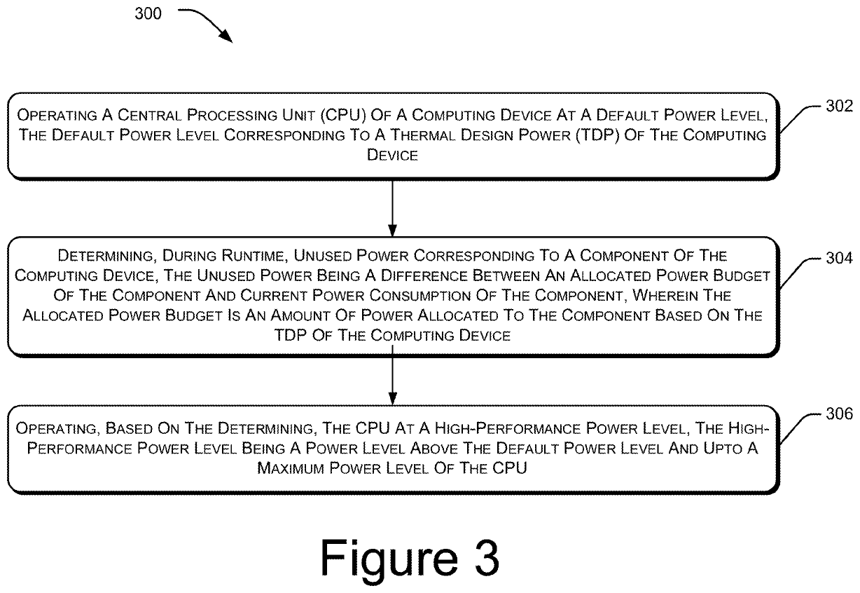

FIG. 3 illustrates a method 300 for allocating a power level to a central processing unit (CPU) of a computing device, according to an example implementation of the present subject matter. Although the method 300 may be implemented in a variety of electronic devices, for the ease of explanation, the present description of the example method 300 for configuring power level of the CPU is provided in reference to the above-described computing device 100. The method 300 may be implemented by a processor(s) or computing device(s) through any suitable hardware, non-transitory machine-readable instructions, or combination thereof.

It may be understood that blocks of the method 300 may be performed by programmed computing devices. The blocks of the method 300 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

Referring to FIG. 3, at block 302, the CPU 102 of the computing device 100 may be operated at a default power level corresponding to a thermal design power (TDP) of the computing device 100. As mentioned previously, the default power level is defined for the CPU for TDP conformance of the computing device 100.

At block 304, an unused power corresponding to a component, such as component 104 of the computing device 100 is determined at run-time. As explained earlier, the unused power is a difference between an allocated power budget of the component 104 and a current power consumption of the component 104. For example, for the purpose of power management in the computing device 100, various components of the computing device 100 may be allocated a power budget, such that when the components operate in accordance with the allocated power budget, the heat generated in the computing device 100 is within the TDP limit. However, in operation, the components may not consume the whole allocated power budget and may consume a power less than the allocated power budget. The component 104 may consume less than allocated power based on whether the component 104 is operational, non-operational or malfunctioning. For instance, a component 104, such as one of several HDDs of the computing device 100 may be non-operational, if the same is not initialized by the OS of the computing device 100. When the component 104 operates at less than the allocated power, the difference between the allocated power budget and the current power consumption constitutes the unused power.

At block 306, the CPU 102 is operated at high-performance power level based on the unused power of the component 104. The high-performance power level, as described previously, is a power level above the default power level and enables the CPU 102 to process workload at a correspondingly higher frequency. Thus, with the CPU 102 having multiple configurable power levels and with the default power level at which the CPU 102 operates upon being initialized being revised, at run-time, to the high-performance power level, provides for efficient utilization of CPU performance.

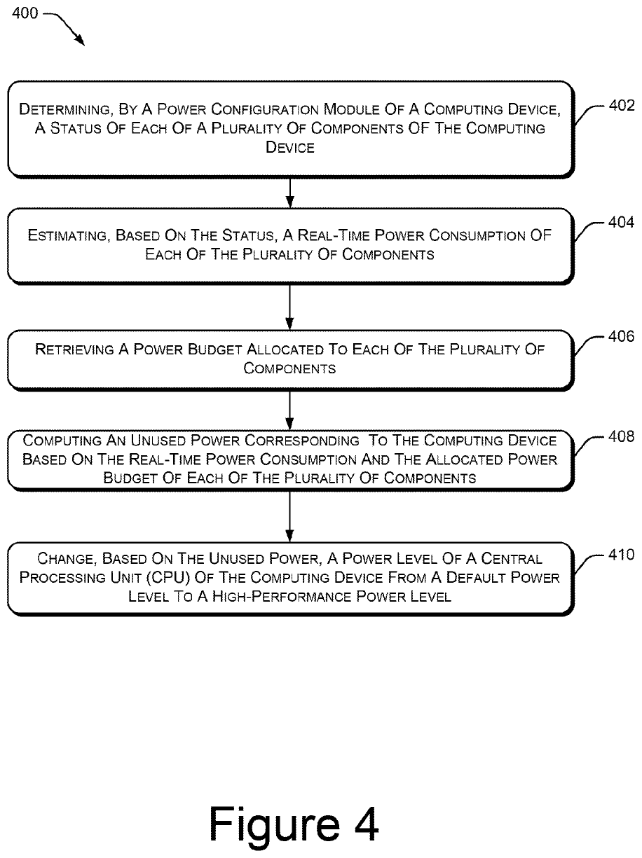

FIG. 4 illustrates a method 400 of determining unused power corresponding to various components of a computing device to change a power level of a CPU of the computing device in real-time, according to an example implementation of the present subject matter. Although the method 400 be implemented in a variety of electronic devices, for the ease of explanation, the present description of the example method 400 to boot the computing device is provided in reference to the above-described computing device 100. The method 400 may be implemented by a processor(s) or computing device(s) through any suitable hardware, non-transitory machine-readable instructions, or combination thereof.

It may be understood that blocks of the method 400 may be performed by programmed computing devices. The blocks of the method 400 may be executed based on instructions stored in a non-transitory computer readable medium, as will be readily understood. The non-transitory computer readable medium may include, for example, digital memories, magnetic storage media, such as magnetic disks and magnetic tapes, hard drives, or optically readable digital data storage media.

Referring to FIG. 4, at block 402, a status of each of a plurality of components of the computing device 100 is determined. The status of a component may indicate whether the component is non-operational, inadequately loaded or malfunctioning. As explained previously, the components of the computing device 100 include processing devices, memory devices as well as interface devices that enable external devices to be interfaced with the computing device 100. In an example implementation, for a component, such as a processing device or a memory device, the status may be determined to be ‘non-operational’ if the component is not detected by the OS of the computing system at run-time, i.e., upon completion of the booting process of the computing device 100. Similarly, the status may be determined to be ‘malfunctioning’, if component is detected by the OS of the computing system at run-time and is found to have crashed or failed.

In an example, if a component being a processing device or a memory device is found to be not ‘non-operational’ or ‘malfunctioning’, it may be considered that the component is operating at full capacity so as to consume the power budget allocated to the component. However, if the component is an interface device, upon making a determination that the component is not ‘non-operational’ or ‘malfunctioning’, and is in operational state, a further status enquiry as to whether the component is operating at full capacity may be made. Accordingly, for such a component, it may be determined that the component is ‘operational’ if, based on a power rating of the external device coupled to the component, the current power consumption by the component is less than the allocated power budget.

At block 404, based on the status of each of the plurality of components, as determined at block 402, a real-time power consumption of each of the corresponding component is estimated. The real-time power consumption of a component being a processing device or a memory device, may be zero if the status of the component is determined to be ‘non-operational’ or ‘malfunctioning’, at block 402. On the other hand, if the status is neither ‘non-operational’ or ‘malfunctioning’, in an example, it may be considered that the real-time power consumption of the component is equal to the allocated power budget of the component. Similarly, the real-time power consumption of a component being an interface device may be zero if the status of the component is determined to be ‘non-operational’ or ‘malfunctioning’. However, if the status is ‘operational, the real-time power consumption may be less than or equal to the allocated power budget of the component and the same is determined by the power configuration module 106 in conjunction with a driver corresponding to the component.

At block 406, a power budget allocated to each of the plurality of components is retrieved. In an example, the power configuration module 106 may access the power configuration data 208 to retrieve the allocated power budget of the components.

Based on the real-time power consumption by each of the components and their respective allocated power budgets, at block 408, an unused power corresponding to the computing device 100 is computed. For that purpose, an unused power corresponding to each of the components may be computed as the difference between the allocated power budget of the respective component and the power consumed by the component in operation. The sum of the unused power of the components together is equivalent to the unused power of the computing device 100.

Thereafter, the method 400 proceeds to block 410, where the unused power of the computing device 100, computed at block 408 may be utilized to enhance the performance of the CPU 102 of the computing device 100. At block 410, the default power level at which the CPU 102 operates upon being initialized is changed to a high-performance power level from amongst the multiple configurable power levels of the CPU 102.

In an example, the high-performance power level may be selected based on the unused power. Considering an example of the CPU 102 operating at 85 W and having configurable power levels of 105 W and 115 W. In an example, if the unused power is determined to be 20 W, the CPU 102 can be configured to a high-performance power level of 105 W (85 W+20 W). In situations where the CPU 102 has no higher configurable power level corresponding to the unused power, the closest higher configurable power level may be selected. Considering above example, where the CPU 102 has configurable power levels of 85 W, 105 w, and 115 W, if unused power is determined to be 40 W and the CPU 102 is operating at the default power level of 85 W, the high-performance power level, based on the unused power, may correspond to about 125w (85 W+40 W). However, since the CPU 102 does not include a configurable power level corresponding to 125 W, the configurable power level 115 W may be selected. Thus, with the power level of the CPU 102 being increased based on the unused power existing in the computing device 100, performance loss by the CPU 102 may be avoided.

In an example, the method of FIG. 4 can be performed periodically after a predefined interval determine the unused power. Further, the method of FIG. 4 may also get trigged based on a change of status of a component, such as hard disk, memory component of the computing device. In an example, the change of status may be, such as malfunctioning if the component at run-time, the component becoming non-operational during run-time etc.

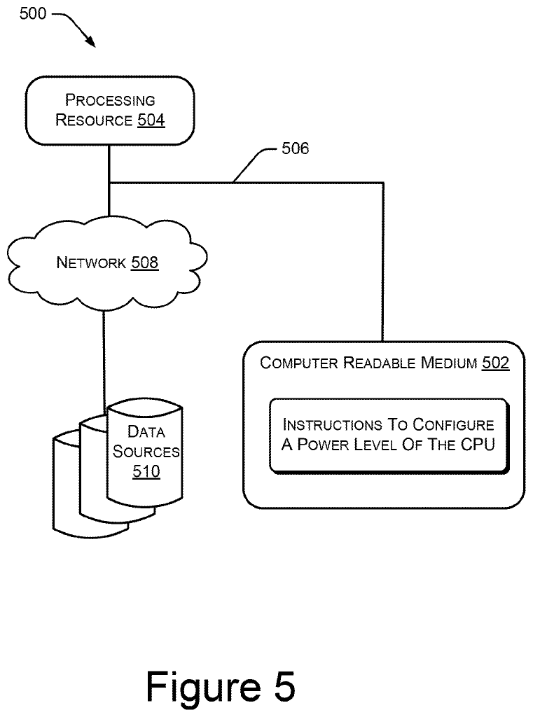

FIG. 5 illustrates a system environment 500 implementing a non-transitory computer-readable medium 502 for allocating power budget to a central processing unit (CPU) of a computing device at run time, according to an example of the present subject matter. In an example implementation, the system environment 500 may be a computing device, such as the computing device 100. The system environment 500 includes a processing resource 504 communicatively coupled to the non-transitory computer-readable medium 502 through a communication link 506. In an example, the processor resource 502 fetches and executes computer-readable instructions from the non-transitory computer-readable medium 502.

The non-transitory computer-readable medium 502 can be, for example, an internal memory device or an external memory device. In an example implementation, the communication link 506 may be a direct communication link, such as any memory read/write interface. In another example implementation, the communication link 506 may be an indirect communication link, such as a network interface. In such a case, the processing resource 504 can access the non-transitory computer-readable medium 502 through a network 508. The network 508 may be a single network or a combination of multiple networks and may use a variety of different communication protocols.

The processing resource 504 and the non-transitory computer-readable medium 502 may also be communicatively coupled to data source(s) 510. The data source(s) 510 may be used to store data, such as power budget data, details of the power level of the CPU of the computing device, in an example. In an example implementation, the non-transitory computer-readable medium 502 includes a set of computer-readable instructions for changing the power level of the computing device. The set of computer-readable instructions can be accessed by the processing resource 504 through the communication link 506 and subsequently executed to configure power level of the CPU.

In an example, the non-transitory computer-readable medium 502 may include a set of instructions implementing a power configuration module 106. The instructions implementing the power configuration module 106 may, in one example, be a code executable to change, at run time of the computing device, the power level of the computing device from a default power level to a high-performance power level, wherein the default power level corresponds to the TDP of the computing device and the high-performance power level is higher than the default power level and may be equal to or less than a maximum power level of the CPU.

In an example, the non-transitory computer-readable medium 502 may include a set of instructions that may, in one example, be executable by the by the processing resource 504 to determine during run-time, an unused power corresponding to a component of the computing device. As explained earlier, the unused power is a difference between a current power consumption of a component and its allocated power budget. The allocated power budget may be based on the TDP of the computing device.

In an example, to determine the unused power corresponding to the component, the instructions may be executable by the processing resource 504 to determine a status of the component. The instructions executable by the processing resource 504 cause determination of a status of the component that may indicate whether the component is operational, malfunctioned, or non-operational. The status of the component may enable estimation of the current power consumption of the component, as explained in the foregoing description.

Once the current power consumption of the component is determined, the instructions may cause the processing resource 504 to determine the unused power by comparing the allocated power budget and the current power consumption of the component. In an example, the component may a USB port and the instruction may cause the processing resource 504 to determine an unused power of the USB port based on a USB-type device coupled to the USB port. Different types of USB-type device may consume different power, for example, a C-type USB device may consume more power than a A-type or B-type USB device. Thus, based on the type of the USB device coupled with the USB port and the allocated power budget of the USB port, the instructions may cause the processing resource 504 to determine the unused power of the USB port.

Based on the unused power, the instructions may cause the processing resource 504 to allocate the unused power of the component to the CPU of the computing device to change a default power level of the CPU to a high-performance level. As the unused power is not reserved for the component and is utilized to boost the power level of the CPU, the CPU is enabled to operate at a higher frequency than that of the default power level leading to faster processing of workloads by the CPU.

Thus, the methods and systems of the present subject matter provide for configuring the power level of a computing device based on unused power of the components. Although implementations of configuring the power level have been described in a language specific to structural features and/or methods, it is to be understood that the appended claims are not necessarily limited to the specific features or methods described. Rather, the specific features and methods are disclosed as example implementations for power management of computing devices.

1. A method comprising:
operating a central processing unit (CPU) of a computing device at a default power level, the default power level corresponding to a thermal design power (TDP) of the computing device;
determining, during run-time, unused power corresponding to a component of the computing device, the unused power being a difference between an allocated power budget of the component and current power consumption of the component, wherein the allocated power budget is an amount of power allocated to the component based on the TDP of the computing device;
operating, based on the determining, the CPU at a high-performance power level, the high-performance power level being a power level above the default power level and up to a maximum power level of the CPU.

2. The method as claimed in claim 1, wherein operating the CPU at the high-performance power level comprises changing power configuration of the CPU from a configuration corresponding to the default power level to a configuration corresponding to the high-performance power level.

3. The method as claimed in claim 1, wherein the component is to allow the computing device to be interfaced with an external device, the method further comprising determining presence of the external device.

4. The method as claimed in claim 1 further comprising, determining if a component is undetected by an operating system (OS) of the computing device.

5. The method as claimed in claim 4 further comprising, determining if the component is malfunctioning.

6. A computing device comprising:
a component having a power budget allocated based on a thermal design power (TDP) of the computing device, wherein, in operation, the component is to consume a current power lower than or equal to the allocated power budget;
a central processing unit (CPU) having a maximum power level at which the CPU can operate and a default power level that corresponds to the TDP of the computing device, the default power level being lower than the maximum power level;
a power configuration module, coupled to the CPU, to:
set a power configuration of the CPU at a configuration corresponding to a high-performance power level, based on an unused power of the component, the high-performance power level being above the default power level and up to the maximum power level of the CPU, and the unused power being a difference between the allocated power budget of the component and the current power of the component.

7. The computing device claimed in claim 6 further comprising a power management device to:
determine, in real time, power consumed by the computing device, wherein the power configuration module is to set the power configuration of the CPU based on the power consumed by the computing device.

8. The computing device claimed in claim 6, wherein the component is a USB port, the computing device further comprising:
a USB driver module to communicatively couple the USB port to the CPU, wherein the USB driver module is to indicate the unused power corresponding to the USB port to the power configuration module based on an USB-type device coupled to the USB port.

9. The computing device claimed in claim 6, wherein the component is a memory component, wherein the power configuration module is to determine unused power corresponding to the memory component based on the memory component being installed in the computing device.

10. The computing device claimed in claim 6, wherein the component is a graphics processing unit (GPU), wherein the power configuration module is to determine unused power corresponding to the GPU based on the GPU being initialized.

11. The computing device claimed in claim 6, wherein the component is an additional CPU, wherein the power configuration module is to determine unused power corresponding to the additional CPU based on an operating system (OS) of the additional CPU being initialized.

12. A non-transitory computer-readable medium comprising instructions executable by a processing resource to:
determine, during run-time, unused power corresponding to a component of a computing device, the unused power being a difference between a power budget allocated to the component and a current power consumption of the component, wherein the power budget is allocated to the component based on a thermal design power (TDP) of the computing device; and
allocate the unused power to a central processing unit (CPU) of the computing device to change a default power level of the CPU, corresponding to the TDP of the computing device, to a high-performance power level, wherein the high-performance power level is a power level above the default power level and up to a maximum power level of the CPU.

13. The non-transitory computer-readable medium as claimed in claim 12 further comprising instructions executable by the processing resource to:
determine, in real time, power consumed by the computing system; and
determine a power configuration of the CPU, corresponding to the high-performance power level, based on the power consumed.

14. The non-transitory computer-readable medium as claimed in claim 12 wherein the component is a USB port, and the instructions executable by the processing resource to determine the unused power corresponding to the USB port based on an USB-type device coupled to the USB port.

15. The non-transitory computer-readable medium as claimed in claim 12 further comprising instruction executable by the processing resource to determine if the component is malfunctioning.
